(19) United States
(12) Patent Application Publication
(10) Pub. No.: US 2026/0337721 A1
(43) Pub. Date: Oct. 29, 2026

(54) PROCESS FOR DE-ZINCING OF GALVANIZED STEEL SCRAP

(71) Applicant: XTRACT GMBH, KONSTANZ (DE)

(72) Inventor: GERHARD AUER, KREFELD (DE)

(73) Assignee: XTRACT GMBH, KONSTANZ (DE)

(21) Appl. No.: 19/101,599

(22) PCT Filed: Aug. 10, 2023
(86) PCT No.: PCT/EP2023/072177

§ 371 Date: Feb. 6, 2025

(30) Foreign Application Priority Data
Aug. 10, 2022 (EP) 22189694.7

(51) Int. Cl. C22B 3/00; C22B 3/08; C22B 7/00; C22B 19/30

(52) U.S. Cl. CPC C22B 19/22; C22B 3/08; C22B 7/007; C22B 19/30

(57) ABSTRACT

A process for a depletion of zinc from a Zn-coated Fe. The process includes subjecting the Zn-coated Fe to a leaching step in an acidic solution having Fe³⁺ so as to yield a reacted acidic solution having Zn²⁺ and Fe²⁺, obtaining a metallic Fe substrate depleted from zinc, and separating Fe²⁺ from Zn²⁺ to provide a Zn²⁺-containing product and a Fe²⁺ salt. During the leaching step, an excess of Fe³⁺ with respect to a metallic Zn exists at an atomic ratio Fe³⁺/Zn⁰ >2 and/or the acidic solution having Fe³⁺ has the Fe³⁺ in a concentration of 1.5 to 60 g Fe³⁺ per kg of the acidic solution at a start of the leaching step.

### CROSS REFERENCE TO PRIOR APPLICATIONS

This application is a U.S. National Phase application under 35 U.S.C. § 371 of International Application No. PCT/EP2023/072177, filed on Aug. 10, 2023 and which claims benefit to European Patent Application No. 22189694.7, filed on Aug. 10, 2022. The International Application was published in English on Feb. 15, 2024 as WO 2024/033477 1 under PCT Article 21(2).

### FIELD

The present invention relates to a process for recycling Zn-coated Fe such as galvanized steel scrap.

### BACKGROUND

Galvanization is the process of coating steel with a thin zinc layer for improved corrosion resistance. The Zn coating is a thin layer of metallic zinc that may also include some dopants, for example, Al, Sn, Ni, Co and Fe. Galvanization can be performed by electrolytic deposition (electrogalvanization) or by dipping the steel body into a liquid of molten zinc. Since galvanization generally improves the steel properties, for example, with respect to corrosion resistance, galvanized steel, with a zinc layer making up 3 to up to 40 kg per ton of steel, is a common industrial product.

The term galvanized steel or galvanized steel scrap as used herein is generally to be understood broadly. Galvanized steel or galvanized steel scrap includes any sheets or substrates of steel that are covered by a zinc layer. The zinc layer may be applied by galvanic or electrolytic deposition, or the zinc layer may be applied by hot dipping of the steel substrate into molten zinc, or by zinc vapor deposition, or by any other method of coating a steel substrate with a zinc layer.

The term galvanized steel or galvanized steel scrap as used herein also includes any material resulting from a subsequent treatment, for example, a subsequent annealing of the zinc coated steel substrate for better adhesion or performance of the zinc layer.

The Zn coating is undesired for the recycling of steel, however, because the Zn coating evaporates at higher temperatures which results in significant amounts of Zn in a flue gas. Scrap comprising Zn coating (galvanized steel scrap or galvanized scrap) has thus a lower value compared to Zn-free scrap, and many descriptions in the prior art exist of attempts to de-zinc galvanized steel scrap.

Different options exist for the depletion of Zn from galvanized steel scrap:
Pyrometallurgical
Hydrometallurgical with alkaline leaching
Hydrometallurgical with acidic leaching

While the performance of acidic leaching is generally better than alkaline leaching, acidic leaching has a significant disadvantage, namely, that the acidic solution not only leaches Zn, but also Fe. The resulting material is therefore not suitable for electrowinning (pure) Zn metal unless an additional separation step to purify Zn is performed. Such an additional separation step is required even if means for minimizing Fe leaching are implemented, for example, by monitoring the electric potential by placing a reference electrode in the leach solution, measuring the corrosion potential, and stopping the reaction when the measured potential arrives at a plateau, as is described in US 2015/0259766.

Acidic de-zincing of galvanized steel scrap for electrowinning of metallic zinc is therefore considered to be economically unfavorable in the prior art as described, for example, in DEZINCING OF GALVANIZED STEEL by J. Grogan, Colorado Scholl of Mines: https://pdfcoffee. com/qdownload/dezincinc-of-galvanized-steel-pdf-pdf-free.html, p. 75, lines 15-16).

WO 2023/089234 describes a process for recovering zinc and iron products from zinc-containing waste materials.

### SUMMARY

In view of this prior art, an aspect of the present invention is to provide for an efficient and economic process for recycling Zn-coated Fe such as galvanized steel scrap.

In an embodiment, the present invention provides a process for a depletion of zinc from a Zn-coated Fe. The process includes subjecting the Zn-coated Fe to a leaching step in an acidic solution which comprises Fe³⁺ so as to yield a reacted acidic solution comprising Zn²⁺ and Fe²⁺, obtaining a metallic Fe substrate depleted from zinc, and separating Fe²⁺ from Zn²⁺ to provide a Zn²⁺-containing product and a Fe²⁺ salt. During the leaching step, an excess of Fe³⁺ with respect to a metallic Zn exists at an atomic ratio Fe³⁺/Zn⁰>2 and/or the acidic solution comprising Fe³⁺ comprises the Fe³⁺ in a concentration of 1.5 to 60 g Fe³⁺ per kg of the acidic solution at a start of the leaching step

### BRIEF DESCRIPTION OF THE DRAWINGS

The present invention is described in greater detail below on the basis of embodiments and of the drawings in which:

FIG. 1 shows a bar chart depicting residual Zn on a steel surface as obtained in Example 4; and

FIG. 2 shows a bar chart depicting residual Zn on a steel surface as obtained in Example 5.

### DETAILED DESCRIPTION

It has surprisingly been found that the use of an acidic solution comprising Fe³⁺ for leaching combines technical and economic advantages which overcomes the previously known drawbacks of acidic leaching. Fe³⁺ is not only an oxidation agent which accelerates Zn leaching, but also generates Fe²⁺ in the leaching step from an otherwise useless waste material, making the separation step suitable for the production of Fe²⁺ salt and thus industrially feasible.

The present invention thus provides a process for depleting metallic Zn from Zn-coated Fe (such as zinc-coated scrap or galvanized steel scrap, respectively), comprising the following steps:
a) Subjecting the Zn-coated Fe to a leaching step in an acidic solution comprising Fe³⁺ to provide an acidic solution containing Zn²⁺ and Fe²⁺;
b) Obtaining a metallic Fe substrate depleted from zinc; and
c) Separating Fe²⁺ from Zn²⁺ to provide a Zn²⁺-containing product and a Fe²⁺ salt.

The acidic solution can, for example, contain Fe³⁺ in a concentration of 1.5 to 60 g Fe³⁺ per kg of solution at the initiation of the leaching step. Such an acidic solution may, for example, be obtained from treatment of materials comprising ferric Fe with acid. In an embodiment, the acidic solution used in step a) can, for example, be obtained by subjecting electric arc furnace dust (EAFD) to an acid treatment.

During leaching, there can, for example, also be an excess of Fe³⁺ with respect to metallic Zn with an atomic ratio Fe³⁺/Zn⁰>2.

Step c) provides two different products, a Zn²⁺-containing product and a Fe²⁺-salt.

The Zn²⁺-containing product obtained in step c) is ZnS obtained from precipitation and is used after conversion into ZnSO₄ to produce metallic Zn by electrowinning. The Zn²⁺-containing product is alternatively a ZnSO₄ or ZnCl₂ solution that is obtained by solvent extraction. The Fe²⁺ salt can, for example, be FeCl₂ or FeSO₄, which, after optional purification, can be sold for wastewater treatment, as a chromate reducing agent for cement, or as an animal food additive.

### The Acidic Solution and the Leaching Step

The acidic solution can be obtained by reacting waste products with fresh or waste acids and can thus, for example, be a waste-derived solution. The waste products or waste acids may be any waste H₂SO₄ (or spent H₂SO₄ or thin H₂SO₄), for example, from TiO₂ production using the sulfate process, waste acidic solutions from manufacturing of zinc, any waste HCl, steel pickling solutions comprising FeCl₂ or FeSO₄, waste metal chlorides from TiO₂ chlorination of TiO₂ manufacturing using the chloride process, iron chloride solutions from production of synthetic rutile, any waste acids comprising Fe³⁺, waste acids used for dissolving Fe oxides or hydroxides, or combinations of the waste products listed above. The pH of the acidic solution can, for example, be 1.5 or lower.

The following industrial residues comprising Fe can, for example, be dissolved in or leached with acids:
EAFD (typically 20-50% Fe; 10-40% Zn)
EAFD from stainless steel production (comprising Cr and Ni)
Slags from the lead industry
Jarosite or Goethite as waste from the zinc industry; Jarosite=MFe₃(OH)₆(SO₄)₂ with M=Na, K or NH₄
Millscale (for example, after elimination of adherent oil)
Dusts from cupola furnaces
Stainless steel production dust
Blast furnace dust and sludge (typically 30-40% Fe; 1-8% Zn)
Basic oxygen furnace (BOF) dust and sludge (up to 70% Fe; <5% Zn)
Spent H₂S absorbers comprising EAFD, or ZnO as absorbent

The following industrial residues comprising Zn can also be dissolved in or leached with acids, given Fe is adjoined into the acidic solution by using acids comprising Fe or by combination with one of the residues listed above:
Zinc ash
Zinc skimmings
Brass ash

Jarosite is obtained primary in zinc manufacturing by precipitation at 95 °C at a pH of 3.5. As Jarosite mainly is landfilled, any use of Jarosite generates additional value by avoiding landfilling costs. The same applies for Goethite that is obtained as waste in primary zinc manufacturing. See WO 2018/109283 for properties and hydrometallurgic treatment of Jarosite.

A further option is the leaching of Fe oxides or compositions comprising Fe oxides and/or metallic Fe. It is also possible to use spent acid comprising Fe²⁺ and/or Fe³⁺ as a leaching agent. Any of these options can be combined resulting in a high degree of freedom for choosing the best scenario from a technical, an economical, and a logistic perspective.

The acidic solution comprising Fe³⁺ can, for example, be based on H₂SO₄ or HCl. Depending on waste materials used, the acid base can be selected accordingly. For example, recycling steel pickling solutions comprising FeCl₂ can, for example, use a HCl based matrix. Solutions comprising FeSO₄ can, for example, use a H₂SO₄ based matrix. If a free choice exists, for example, when dissolving EAFD in acid, the sulfate-based matrix can be used because the FeSO₄*7 H₂O crystals remove a significant amount of water from the system.

The acidic solution used in the process of the present invention can, for example, comprise 1.5-60 g, for example, 4-50 g, for example, 10-40 g, and, for example, 14 to 28 g Fe³⁺ per kg of solution. Determination of Fe³⁺ is made by analyzing total dissolved Fe by ICP and Fe²⁺ by titration with permanganate, with Fe³⁺ being the difference between total dissolved Fe and Fe²⁺.

The acidic solution used in the process of the present invention can, for example, comprise Zn²⁺ obtained from leaching industrial waste materials comprising Zn (see above) with acids, for example, H₂SO₄. The acidic solution can, for example, be prepared by leaching electric arc furnace dust (EAFD) with sulfuric acid.

The reaction of EAFD with sulfuric acid can, for example, be made using sulfuric acid of >90% H₂SO₄.

In an embodiment, EAFD and sulfuric acid can, for example, be fed simultaneously into a mixing area and then are displaced from the mixing area. The reaction of EAFD and sulfuric acid can thus be performed in a continuous process. For example, EAFD and sulfuric acid are fed simultaneously into a screw reactor and are conveyed inside the screw reactor to the opposite end. The screw reactor can, for example, be double walled and can be heated or cooled depending on the residence time in the reactor and the amount of heat generated by the reaction. The temperature of the mixture can thus be maintained for a longer period at temperatures >200 °C.

The acidic solution comprising Fe³⁺ can, for example, have more than 25%, for example, more than 50%, for example, more than 75% of Fe in oxidation state Fe³⁺.

An embodiment of the present invention is:
leaching a Zn containing waste material, for example, EAFD, with H₂SO₄,
separating undissolved material and obtaining an acidic solution comprising H⁺, Zn²⁺, and Fe³⁺,
using the acidic solution for depletion of zinc from galvanized steel scrap or a composition comprising galvanized steel scrap,
obtaining scrap depleted from zinc and a solution comprising ZnSO₄ and FeSO₄, and
separating Fe²⁺ from Zn²⁺ to provide a Zn²⁺-containing product and a Fe²⁺ salt.

Dissolving EAFD in H₂SO₄ can be performed in a single step reaction with concentrated H₂SO₄ or in a two-step dissolution with diluted H₂SO₄ in step 1 and concentrated H₂SO₄ in step 2. The diluted H₂SO₄ can be any waste H₂SO₄, or the solution obtained after crystallization and separation of FeSO₄*7 H₂O according to the inventive process. The acidic solution resulting from EAFD dissolving comprises H⁺, Fe³⁺, and Zn²⁺, and can comprise Fe²⁺.

After reaction of the waste material with acid, the dissolution in water or diluted acid can be performed using reducing agents. Metallic Zn or Fe from scrap or H₂ generated during Zn leaching can, for example, be used.

In the state of the art, acidically leached Zn is oxidized by H⁺, which is known to lead to kinetic problems due to the overpotential associated with H₂ generation. In contrast, the present invention provides Fe³⁺ as an oxidation agent for metallic Zn. This avoids or at least reduces the kinetic problems with overpotential for H₂ generation and can thus result in an accelerated Zn leaching. H₂ generation can also be reduced or even avoided completely, and the reducing power of Zn is not useless but is highly valuable for the reduction of Fe³⁺ instead of H₂ being blown off.

There can, for example, be more than one leaching step (with at least one leaching step being performed with a stoichiometric excess of metallic Zn in relation to Fe³⁺, and at least one leaching step being performed with a stoichiometric excess of H⁺ and Fe³⁺ in relation to metallic Zn). For the leaching step with stoichiometric excess of metallic Zn in relation to Fe³⁺, the concentration of H₂SO₄ can, for example, be <10%, for example, <4%. It is thus possible to obtain steel scrap with <0.5%, for example, <0.2%, for example, <0.1% of residual Zn and a solution free from Fe³⁺ with <2%, for example, <1.5%, for example, <1% of H₂SO₄. Any H₂SO₄ concentration herein means free H₂SO₄.

The present invention also provides a Zn-coated Fe (or galvanized steel) that is covered by an acidic solution comprising 1.5-60 g, for example, 4-50 g, for example, 10-40 g Fe³⁺ per kg of solution.

The acidic solution comprising Fe³⁺ can, for example, be used in an amount so that an excess of Fe³⁺ temporarily exists with respect to metallic Zn provided as a coating. This excess can, for example, be present at the beginning of the process. It could also, however, be present at the end of the leaching step. The atomic ratio Fe³⁺/Zn⁰ can, for example, be >2, for example, >4, for example, >10. Some metallic Fe may be consumed for reduction of Fe³⁺ as a result therefrom.

This allows a more thorough leaching for improved Zn removal. If scrap is in the form of pressed packages, some surface area coated with Zn is not directly accessible for leaching agents. A certain degree of “overleaching” can consequently help approaching (close to) 100% Zn depletion; “hot dipped” Zn layers comprise Zn-Fe interlayers that can result in co-leaching of metallic Fe. This “overleaching” (meaning dissolving some metallic Fe from the scrap) can be performed to a variable extent depending on chemical and economic conditions.

A slight “overleaching” saves metallic Fe for further use (for example, in steelmaking), a moderate “overleaching” can be reasonable or necessary for maximum Zn depletion (especially in case of galvanealed Zn layers), and a more thorough “overleaching” can be promising for maximizing output of Fe salt, especially if additional waste streams comprising Fe(III) can be converted into valuable products (for example, 1 metallic Fe converts 2 Fe³⁺ from Jarosite or Goethite into 3 valuable Fe²⁺ species).

The leaching rate (or Zn removal rate) of metallic Zn can, for example, be >90% or >98% or >99%, for example, >99.5%, for example, >99.8%.

Accepting some “overleaching” of Fe can also provide a more efficient Zn removal in case of a polymer, a painting or a lacquer being on top of the Zn coated steel substrate.

Another embodiment is the dissolution of Fe(III) compounds such as Fe oxides, Goethite or Jarosite in sulfuric acid or in the acidic solution comprising H⁺, Zn²⁺, and Fe³⁺. The Fe³⁺ is reduced to Fe²⁺ in the subsequent reaction with galvanized steel scrap.

Taking Zn from galvanized steel scrap as a reducing agent for Fe³⁺ obtained after dissolution of EAFD saves the life for Fe as metal; Fe has more value as metal in scrap than as Fe²⁺.

The reaction of the acidic solution with the galvanized steel scrap can, for example, be continued until all or nearly all Zn has been dissolved (reaction A) and (subsequently) all Fe³⁺ has been reduced (reaction B):

Zn+2 Fe³⁺=>Zn²⁺+2 Fe²⁺ Reaction A

2 Fe³⁺+Fe=>3 Fe²⁺ Reaction B

The leaching of metallic Zn can be performed in a two-step or in a multi-step process. Fresh galvanized steel scrap can be subjected to a first leaching step with an acidic solution obtained from previous leaching steps, or with a recycled solution from another process step, for example, solution obtained from the first ZnS precipitation step. Further leaching steps can follow using other solutions with a higher acidity or a higher Fe³⁺ concentration for improved leaching of the very last fraction of the metallic Zn. This can be performed, for example, by dipping baskets with galvanized steel scrap into the corresponding solutions or by passing different leaching solutions one after another through a reactor filled with the scrap.

A partial recycling of solutions can help in optimizing the acidity for leaching steps, adjusting the Fe³⁺ level for an optimized Zn leaching, increasing ion concentration for more efficient separation steps, or fine-tuning pH for ZnS precipitation. For example, the solution obtained after crystallization and separation of FeSO₄*7 H₂O can be used due to its acidity in the process step of manufacturing the acidic solution comprising Fe³⁺.

The pH can be raised if required for the subsequent step of ZnS precipitation or solvent extraction of Zn²⁺. This can be achieved by a supply of new Zn coated material (reaction C), or by continuing a leaching of metallic Fe (overleaching; reaction D), or by alkaline materials (reaction E), or by reaction with new waste materials (reaction F):

Zn+H₂SO₄=>ZnSO₄+H₂ Reaction C

Fe+H₂SO₄=>FeSO₄+H₂ Reaction D

2 NaOH+H₂SO₄=>Na₂SO₄+H₂O Reaction E

Fe₂O₃+3 H₂SO₄=>Fe₂(SO₄)₃+3 H₂O Reaction F

Reaction E is least favored due to the generation of Na₂SO₄ which must be separated or ends in a wastewater stream. Reaction C and D has the disadvantage of generating hydrogen, but the advantage of simply continuing the leaching step and no additional treatment step being necessary. Reaction C has the advantage over reaction D that no metallic Fe is lost.

In reaction F, the raising of the pH can be achieved by a dissolution of iron oxide (for example, from wastewater treatment after crystallization of FeSO₄*7 H₂O ), a dissolution of EAFD, or other waste materials. In an embodiment, reaction F is not, for example, performed after the reaction A or B, but after a part of the ZnS has been precipitated and separated. However, reaction F requires another treatment according to reaction A or B for reduction of Fe³⁺ to Fe²⁺.

The overall set-up of process parameters is heavily influenced by acid consumption for dissolving the waste materials for generation of the acidic solution. A high acid ratio yields better dissolution rates for Zn and Fe from waste materials, but is also more effort for maintaining acid balance for a complete and selective precipitation of ZnS. Depending on the relative volume of waste material and galvanized steel scrap, on Fe and Zn content of each material, on price for Zn and FeSO₄*7 H₂O, or on logistic or quality constraints, the process can be adjusted with a considerable amount of freedom.

Process control of the Zn leaching step can be performed by monitoring redox potential. The complete dissolution of Zn and reduction of Fe³⁺ are each indicated by a characteristic feature of redox potential (see US 2015/0259766). It is possible to recycle any acidic solution from the inventive process partly back into a previous process step, for example, the solution obtained after Zn leaching, the solution obtained after ZnS precipitation and separation, or the solution obtained after crystallization of FeSO₄*7 H₂O. This can help improve the acid balance of the inventive process. The acid needed for generation of the acidic solution by dissolving a waste product can, for example, originate in part from recycling from a later process step.

Use of waste materials as source for Fe³⁺ can generate another source of revenue due to negative prices for some waste products (for example, EAFD with a low Zn content or Jarosite or Goethite). This applies especially for waste products with a low zinc content with no satisfactory process currently existing for recycling those materials.

### Zn-Coated Fe Covered by Fe³⁺-Containing Acidic Solution

In line with the previous description of the acidic solution and the leaching step, the present invention also provides the product that is present at the beginning of the leaching step. The present invention thus also provides Zn-coated Fe that is covered by an acidic solution comprising 1.5-60 g, for example, 4-50 g, for example, 10-40 g Fe³⁺ per kg of solution. The Zn-coated Fe as well as the acidic solution are described in detail above.

### The Galvanized Steel Scrap

Galvanized steel scrap consists of or comprises a Fe substrate that is coated with a zinc layer. Fe substrates coated with zinc are often used for corrosion resisting products, for example, in the automotive industry. The protective layer is sometimes not pure zinc, but can contain other elements such as Sn, Al, or Ni.

Galvanized steel scrap can be subjected to shredding or be pressed into packages that are easy to handle, for example, by dipping of a package into the leaching liquid (i.e., the acidic solution comprising Fe³⁺ ) and taking out the package again following the Zn leaching step. Another option is filling a vessel or a column with the galvanized steel scrap and subjecting the vessel or column to the acidic solution in a continuous or discontinuous manner. Another option is putting the galvanized steel scrap into a basket and immersing the basket in the leaching liquid., i.e., the acidic solution comprising Fe³⁺. Yet another option is shredding the galvanized steel scrap and conveying this material on a moving belt and passing an area of being sprayed by the acidic solution and a subsequent area of being sprayed by water.

After finishing the leaching of Zn, the metallic Fe substrate depleted from zinc can be washed with diluted acid and/or water for removing adhering solution comprising Zn and anions like sulfate or chloride.

The Fe substrate depleted from zinc can be used as a high-quality raw material for iron smelting processes, for example, for steelmaking using an electric arc furnace, for a blast oxygen furnace, or for casting.

### The Separation Step

Separation of dissolved Zn²⁺ and Fe²⁺ can be performed by precipitation of ZnS by bubbling H₂S into the solution.

Another option is:
precipitation of the obtained Zn²⁺ in the solution as ZnS,
separating the ZnS from the solution comprising dissolved Fe²⁺,
crystallization of the Fe compound by evaporation of water and/or lowering temperature, and
separation of the crystals of the Fe compound and recycling the obtained liquid phase back into one of the previous process steps.

The pH drops during precipitation of ZnS with H₂S. In an embodiment of the present invention, the precipitation of ZnS is performed in (at least) a two-step process. In a first step, part of the Zn²⁺ is precipitated as ZnS using H₂S off-gas from second step or H₂S obtained from stripping the solution obtained after the second step is precipitated and separated as ZnS. In the second step, a high concentration of H₂S is used in order to shift the equilibrium towards ZnS precipitation. Another option is precipitation of ZnS using Na₂S or (NH₄)₂S.

An embodiment of the present invention includes reacting the precipitated ZnS with H₂SO₄, resulting in a ZnSO₄ solution and gaseous H₂S, and recycling the H₂S obtained for precipitation of ZnS again. The moist ZnS filtercake can, for example, be reacted with diluted H₂SO₄. It can be necessary to strip residual H₂S by N₂ or air for shifting the equilibrium in the desired direction, or reacting the H₂S with NH₄OH or NaOH for obtaining Na₂S or (NH₄)₂S.

ZnS can, however, be the material of choice in case a transport over a large distance to a zinc manufacturing location is necessary.

Synergies exist for dissolving EAFD with H₂SO₄ and de-zincing of galvanized steel scrap in purification (for example, Cu, Cd, Mn, Ni from Zn—Ni coatings)—if purification is performed for creating higher value Zn²⁺ solution.

H₂S can be produced from H₂ and S or can be obtained as a by-product from the production of coke. H₂S may also be obtained from spent absorbers for H₂S, for example, EAFD as an absorber for H₂S.

There is wide industrial usage of metal oxides as H₂S removal adsorbents from industrial gases such as synthesis gas, coke gas from steel production, fuel cell hydrogen, sulfur recovery unit tail gas, and bio/natural gas. These materials can be used for H₂S generation and at the same time can be used as a source for Fe and/or Zn in manufacturing the acidic solution comprising Fe³⁺.

Another option for separation of dissolved Zn²⁺ and Fe²⁺ is solvent or membrane extraction. Zn²⁺ can, for example, be transferred into an organic phase, for example, D2EHPA, di-(2-ethyl hexyl) phosphoric acid. D2EHPA is a cheap and widely available reagent.

### The Process Steps of Zn²⁺ Extraction

D2EHPA is dissolved in an organic solvent, typically an inert hydrocarbon such as kerosene or naphtha. This organic phase is immiscible with the aqueous solution containing Zn²⁺. This D2EHPA-containing organic phase is brought into contact with the aqueous solution containing Zn²⁺:

Zn²⁺ (aq)+2 D2EHPA (org) [symbol] Zn(D2EHPA)2 (org)

The Zn(D2EHPA)2 complex is more soluble in the organic phase than in the aqueous phase. As a result, the complex transfers from the aqueous phase into the organic phase.

The loaded organic phase comprising the extracted Zn(D2EHPA)2 complex is then separated from the aqueous phase by settling, centrifugation, or decantation.

To recover the extracted zinc from the organic phase, H₂SO₄ is used as stripping agent. After stripping the zinc from the organic phase, the D2EHPA can be regenerated and reused in the extraction process.

The solvent extraction process can, for example, involve multiple extraction and stripping stages to increase the overall efficiency of zinc recovery.

The pH of the solution to be treated by extraction can, for example, be >0.5, for example, >1.0, for example, >1.5.

As Mn²⁺ is extracted together with Zn²⁺, a need exists for separating Mn. This can be performed by cementation with fine Zn powder: Zn+Mn²⁺=>Zn²⁺+Mn. Mn can be separated by sedimentation, filtration or centrifugation together with unreacted Zn. Another option is oxidation of Mn²⁺ to MnO₂. This can, for example, be performed by O₂, O₃, H₂O₂, or H₂SO₅ with a subsequent separation of MnO₂ by sedimentation, filtration or centrifugation.

### Production of Fe Salt

The solution obtained after ZnS precipitation and separation of the precipitate or removal of Zn²⁺ by solvent or membrane extraction is used for reclamation of the Fe compound. Stripping of residual H₂S in the solution can be performed by N₂. Crystallization can, for example, be used to obtain a solid Fe compound from solutions comprising FeSO₄. Water can, for example, be removed from the Fe²⁺ solution by vacuum evaporation and by supplying heat in order to prevent the temperature from dropping too quickly. The temperature can, for example, be allowed to drop down to +5 °C, and then separating the FeSO₄*7 H₂O crystals by filtration or centrifugation. The process of crystallization and separation of FeSO₄*7 H₂O from acidic solutions belongs to the state of the art in TiO₂ production. Specific parameters depend on the composition of the solution. General principles and considerations are described in DE 10 2007 032 418.

The FeSO₄ concentration in the solution can, for example, be >100 g/l. Due to the large amount of crystal water being bound in FeSO₄*7 H₂O , water is efficiently removed from the solution, resulting in a significant drop of pH. The final concentration of saturated solution at +5 °C is approximately 35-40 g/l Fe²⁺.

Due to evaporation of water from the FeSO₄ solution and water capturing of the heptahydrate, the acidity of the solution significantly increases (pH <<0.5). This solution or part of this solution can therefore be used for closing the loop and recycling back into one of the previous steps, i.e., for reaction with EAFD or for Zn leaching from galvanized steel scrap.

A similar situation is found for the crystallization of FeCl₂ as FeCl₂*4H₂O .

At least part of this solution leaves the process as wastewater and a sink for some ions, for example, Na or K. Fe can, for example, be precipitated by alkaline treatment, separated, and recycled into one of the preceding steps, for example, for generation of the acidic solution comprising Fe³⁺ or for raising the pH according to reaction F.

### Electrowinning

Careful precipitation of ZnS and washing the precipitate with diluted H₂SO₄ (pH ~2) can achieve a nearly complete separation of Fe and other impurities. This ZnS can be fed into the primary Zn production process.

After conversion of ZnS into ZnSO₄ solution by reacting with H₂SO₄, the solution obtained can be used for electrowinning of metallic zinc. A further purification via a cementation step with metallic zinc powder is possible for removing even more impurities, for example, Ni, Cd, Cu, and Fe. As there are only small concentrations of these impurities present, the demand for zinc powder is very low.

In summary, the process of the present invention offers significant advantages:
No major waste streams from EAFD recycling
Hydrometallurgic processes generally have less energy consumption and a lower CO₂ footprint compared to thermal processes (for example, the Waelz process)
The leaching step has a maximum efficiency for Zn depletion (implies some co-leaching of Fe)
High flexibility
The possibility for shifting the process towards more H₂ generation for further use
The separation step can use H₂S for ZnS precipitation, if inexpensive H₂S is available, or use solvent extraction if no H₂S or if no inexpensive H₂S is available

The present invention also provides the use of an acidic solution comprising Fe³⁺ for use as an oxidizing agent, for example, for de-zincing of galvanized steel, wherein the waste acidic solution is obtained by reacting is EAFD with sulfuric acid.

### Example 1: Recycling of Electric Arc Furnace Dust (EAFD) and De-Zincing of Galvanized Steel Scrap

An acidic solution is prepared by reacting electric arc furnace dust (EAFD) with concentrated sulfuric acid and dissolving the obtained reaction product in water. After separation of the solid residue, an acidic solution comprising Fe³⁺ and Zn²⁺ is obtained.

Galvanized steel scrap is leached with this acidic solution until the Zn coating is dissolved to >99% and the Fe³⁺ is reduced to Fe²⁺. This can be performed by dipping baskets filled with scrap into acidic solution or by passing acidic solution through a column filled with scrap. The obtained Zn-free metallic Fe substrate can be washed with water, dried, and used as a Fe resource for steelmaking or in foundries.

A typical mass ratio of EAFD and galvanized steel scrap is 1:8.

The solution obtained from the Zn leaching step comprising Zn²⁺ and Fe²⁺ is treated with H₂S gas for precipitating of ZnS. ZnS is separated by filtration or centrifugation and washed with diluted H₂SO₄ (pH ~2) to remove FeSO₄. The ZnS can be used as a raw material in primary zinc production or can be converted into a ZnSO₄ solution by dissolving in H₂SO₄ for electrowinning of zinc.

The FeSO₄ solution obtained after separation of the ZnS precipitate is taken for crystallization of FeSO₄*7 H₂O (copperas) by vacuum evaporation of water and the system is allowed to cool down to 5 °C. The FeSO₄ solution obtained after separation of the copperas can be recycled back (completely or in part) into one of the previous process steps.

Products obtained: Zn depleted scrap, ZnS (or ZnSO₄), and FeSO₄*7 H₂O (copperas).

### Example 2: Recycling of Jarosite and De-Zincing of Galvanized Steel Scrap

Jarosite is dissolved in diluted H₂SO₄ (for example, waste H₂SO₄ from TiO₂ production).

Galvanized steel scrap is leached with this acidic solution until the Zn coating is dissolved to >99% and the Fe³⁺ is reduced to Fe²⁺. This can be performed by dipping baskets filled with scrap into acidic solution or by-passing acidic solution through a column filled with scrap. The obtained Zn-free metallic Fe substrate can be washed with water, dried, and used as Fe resource for steelmaking or in foundries.

The solution obtained from the Zn leaching step comprising Zn²⁺ and Fe²⁺ is treated with H₂S gas for precipitating of ZnS. ZnS is separated by filtration or centrifugation and washed with diluted H₂SO₄ (pH ~2) to remove FeSO₄. The ZnS can be used as a raw material in primary zinc production or can be converted into a ZnSO₄ solution by dissolving in H₂SO₄ for electrowinning of zinc.

The FeSO₄ solution obtained after separation of the ZnS precipitate is taken for crystallization of FeSO₄*7 H₂O (copperas) by vacuum evaporation of water and the system is allowed to cool down to 5 °C. The FeSO₄ solution obtained after separation of the copperas can be recycled back (completely or in part) into one of the previous process steps.

Products obtained: Zn depleted scrap, ZnS (or ZnSO₄), FeSO₄*7 H₂O (copperas). Three low-cost waste materials are thereby recycled and converted into valuable products: Jarosite, waste diluted H₂SO₄, galvanized steel scrap.

### Example 3: Recycling of Electric Arc Furnace Dust (EAFD) and De-Zincing of Galvanized Steel Scrap

An acidic solution is prepared by reacting electric arc furnace dust (EAFD) with concentrated sulfuric acid and dissolving the obtained reaction product in water. After separation of the solid residue, an acidic solution comprising Fe³⁺ and Zn²⁺ is obtained.

Galvanized steel scrap is leached with this acidic solution until the Zn coating is dissolved to >99% and the Fe³⁺ is reduced to Fe²⁺. This can be performed by dipping pressed scrap elements or baskets filled with scrap into the acidic solution or by passing the acidic solution through a vessel filled with scrap. The obtained Zn-free metallic Fe substrate is then washed with water, dried, and used as a Fe resource for steelmaking or in foundries.

The solution obtained from the Zn leaching step comprising Zn²⁺ and Fe²⁺ is treated by solvent extraction with D2EHPA in kerosene. The loaded organic phase, comprising the extracted Zn(D2EHPA)2 complex, is then separated from the aqueous phase by settling. The organic phase is mixed with H₂SO₄ as a stripping agent. After stripping the zinc from the organic phase, the D2EHPA is reused for the extraction process.

Mn²⁺ is converted into MnO2 by oxidation with O₃ and subsequently separated by filtration.

The FeSO₄ solution obtained after solvent extraction of Zn²⁺ is taken for crystallization of FeSO₄*7 H₂O (copperas) by vacuum evaporation of water and the system is allowed to cool down to 5 °C. The FeSO₄ solution obtained after separation of the crystalline copperas can be recycled back (completely or in part) into one of the previous process steps.

Products obtained: Zn depleted scrap, ZnSO₄, MnO₂, and FeSO₄*7 H₂O (copperas).

### Example 4: De-Zincing of Galvanized Steel Scrap Galvanized steel scrap comprising 0.9% Zn is leached with:

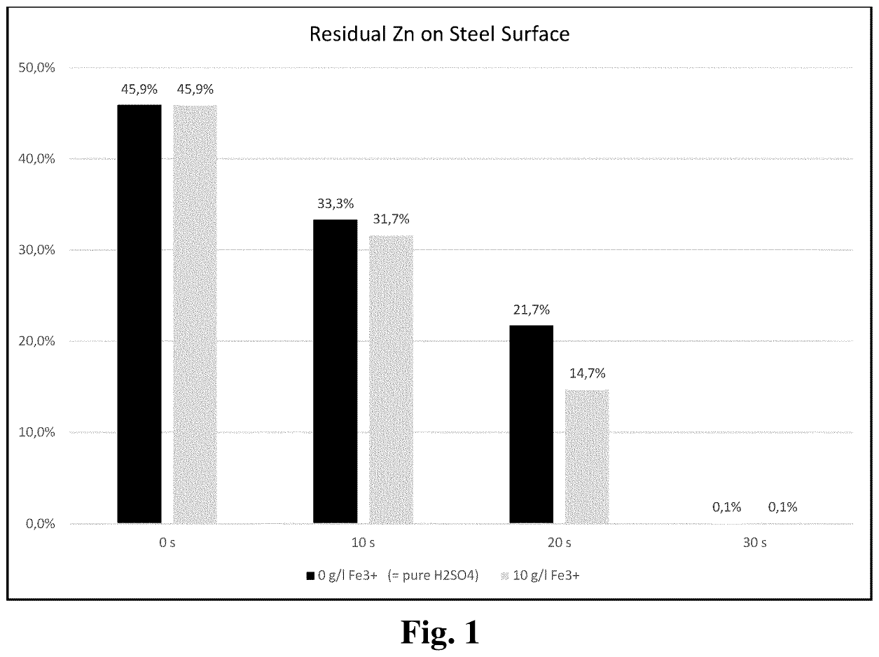

(a) an acidic solution comprising 150 g/l H₂SO₄
(b) an acidic solution comprising 150 g/l H₂SO₄ and 10 g/l Fe³⁺ (as Fe₂(SO₄)₃) for 10, 20, and 30 seconds. After the leaching step, the scrap samples are washed with deionized water and dried prior to XRF characterization. The results (in FIG. 1) with the bars indicating the surface Zn concentration as determined by XRF clearly reveal the acceleration of Zn dissolution in the presence of Fe³⁺.

### Example 5: De-zincing of Galvanized Steel Scrap

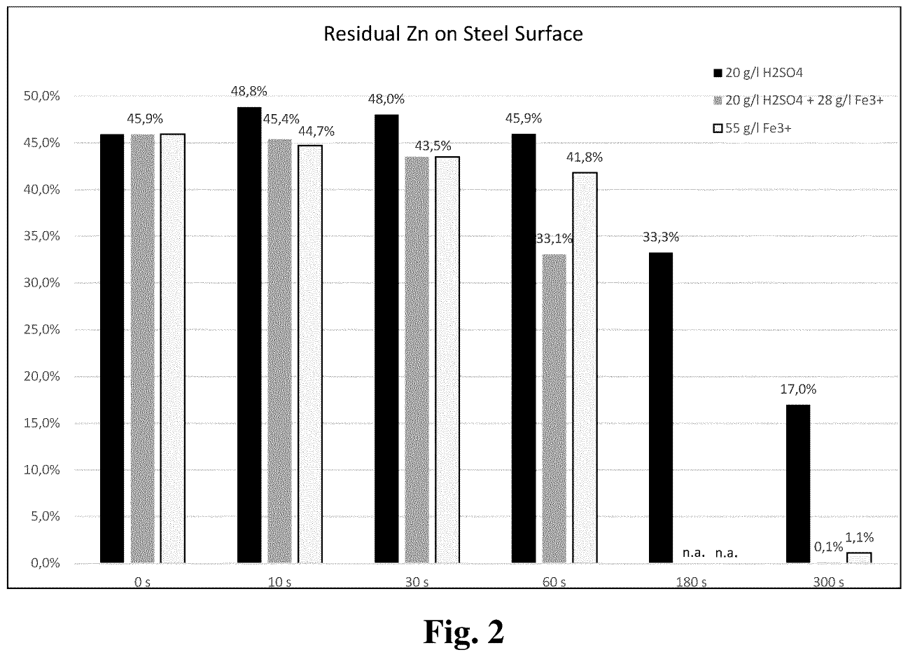

Galvanized steel scrap comprising 0.9% Zn is leached with:
(a) an acidic solution comprising 20 g/l H₂SO₄
(b) an acidic solution comprising 20 g/l H₂SO₄ and 28 g/l Fe³⁺ (as Fe₂(SO₄)₃)
(c) a solution comprising 55 g/l Fe³⁺ (as Fe₂(SO₄)₃) (pH of solution <4)
for up to 300 seconds. After the leaching step, the scrap samples are washed with deionized water and dried prior to XRF characterization. The results (in FIG. 2) with the bars indicating the surface Zn concentration as determined by XRF clearly reveal the acceleration of Zn dissolution in the presence of Fe³⁺.

After 300 seconds, the residual Zn on the steel surface is 0.1% and 1.1% for solutions comprising Fe³⁺, and 17% for a H₂SO₄ solution without Fe³⁺.

The present invention is not limited to embodiments described herein; reference should be had to the appended claims.

What is claimed is:

1-13. (canceled)

14: A process for a depletion of zinc from a Zn-coated Fe, the process comprising:
subjecting the Zn-coated Fe to a leaching step in an acidic solution which comprises Fe³⁺ so as to yield a reacted acidic solution comprising Zn²⁺ and Fe²⁺, wherein,
during the leaching step, an excess of Fe³⁺ with respect to a metallic Zn exists at an atomic ratio Fe³⁺/Zn⁰>2, and/or
the acidic solution comprising Fe³⁺ comprises the Fe³⁺ in a concentration of 1.5 to 60 g Fe³⁺ per kg of the acidic solution at a start of the leaching step;
obtaining a metallic Fe substrate depleted from zinc; and
separating Fe²⁺ from Zn²⁺ to provide a Zn²⁺-containing product and a Fe²⁺ salt.

15: The process as recited in claim 14, wherein,
the acidic solution which comprises Fe³⁺ is made from a dissolution of electric arc furnace dust (EAFD), from a dissolution of Jarosite, from a dissolution of millscale, or from a dissolution of Goethite, or
the acidic solution which comprises Fe³⁺ is made from a waste H₂SO₄ from a TiO₂ production using a sulfate process, from acidic solutions from a manufacturing of zinc, from a steel pickling solution comprising FeCl₂ or FeSO₄, from a waste metal chloride from a TiO₂ chlorination of TiO₂ manufacturing using a chloride process, from iron chloride solutions from a production of synthetic rutile, or
from any combination thereof.

16: The process as recited in claim 14, wherein the acidic solution further comprises Zn²⁺.

17: The process as recited in claim 14, wherein,
the subjecting the Zn-coated Fe to the leaching step in the acidic solution which comprises Fe³⁺ so as to provide the reacted acidic solution comprising Zn²⁺ and Fe²⁺ includes a plurality of leaching steps comprising at least a first leaching step and a second leaching step,
the first leaching step is performed with a stoichiometric excess of the metallic Zn in relation to Fe³⁺, and
the second leaching step is performed with a stoichiometric excess of H⁺ and Fe³⁺ in relation to the metallic Zn.

18: The process as recited in claim 14, wherein, during the subjecting of the Zn-coated Fe to the leaching step in the acidic solution which comprises Fe³⁺ so as to provide the reacted acidic solution comprising Zn²⁺ and Fe²⁺, the atomic ratio of the excess of Fe³⁺ with respect to the metallic Zn, Fe³⁺/Zn⁰, is >4.

19: The process as recited in claim 14, wherein, during the subjecting of the Zn-coated Fe to the leaching step in the acidic solution which comprises Fe³⁺ so as to provide the reacted acidic solution comprising Zn²⁺ and Fe²⁺, the atomic ratio of the excess of Fe³⁺ with respect to the metallic Zn, Fe³⁺/Zn⁰, is >10.

20: The process as recited in claim 14, wherein, the separating of Fe²⁺ from Zn²⁺ to provide the Zn²⁺-containing product and the Fe²⁺ salt provides an acid, and the method further comprises:
using the acid to treat a waste material so as to produce the acidic solution which comprises Fe³⁺.

21: The process as recited in claim 14, further comprising:
leaching a Zn containing waste material with H₂SO₄ so as to obtain a residue of undissolved material and the acidic solution which comprises Fe³⁺, wherein the acidic solution further comprises H⁺ and Zn²⁺; and
separating the residue of undissolved material from the acidic solution comprising Fe³⁺, H⁺ and Zn²⁺;
wherein,
the step of subjecting of the Zn-coated Fe to the leaching step in the acidic solution which comprises Fe³⁺ so as to yield a reacted acidic solution comprising Zn²⁺ and Fe²⁺ uses a galvanized steel scrap or a composition comprising a galvanized steel scrap as the Zn-coated Fe and the acidic solution comprising Fe³⁺, H⁺ and Zn²⁺ to thereby obtain a steel scrap as the metallic Fe substrate which has been depleted from zinc and a solution comprising ZnSO₄ and FeSO₄.

22: The process as recited in claim 21, wherein the Zn containing waste material is electric arc furnace dust (EAFD).

23: The process as recited in claim 14, wherein, a leaching rate of the metallic Zn from the Zn-coated Fe is >90%.

24: The process as recited claim 14, wherein the separating of Fe²⁺ from Zn²⁺ to provide the Zn²⁺-containing product and the Fe²⁺ salt is provided by precipitating the Zn²⁺-containing product as ZnS.

25: The process as recited in claim 14, wherein the separating of Fe²⁺ from Zn²⁺ to provide the Zn²⁺-containing product and the Fe²⁺ salt is provided by a solvent extraction.

26: The process as recited in claim 14, wherein,
the separating of Fe²⁺ from Zn²⁺ provides the Zn²⁺-containing product and the Fe²⁺ salt dissolved in a solution, and
the process further comprises:
precipitating the Zn²⁺-containing product as ZnS;
separating the ZnS from the solution;
crystallizing a Fe compound by evaporating water in the solution and/or by lowering a temperature of the solution;
separating out the crystals of the Fe compound; and
recycling an obtained liquid phase into at least one of a previous process step.

27: The process as recited in claim 26, further comprising:
reacting the ZnS with H₂SO₄ so as to provide ZnSO₄ and H₂S; and
recycling the H₂S obtained to precipitate the Zn²⁺-containing product as ZnS.

28: The process as recited in claim 14, wherein the Zn-coated Fe is a Zn depleted scrap which is obtained as a raw material for an iron smelting process.

29: The process as recited in claim 28, wherein the iron smelting process is an electric arc furnace, a blast furnace, a basic oxygen furnace, or a casting.
